(19) United States
(12) Patent Application Publication
(10) Pub. No.: US 2015/0237814 A1
(43) Pub. Date: Aug. 27, 2015

(54) AUTOMATED TREE AND PLANT WATERING SYSTEM

(71) Applicant: BROKER ALLIANCE NETWORK, INC., Ballston Spa, NY (US)

(72) Inventor: Peter C. Moran, Ballston Spa, NY (US)

(73) Assignee: BROKER ALLIANCE NETWORK, INC., Ballston Spa, NY (US)

(21) Appl. No.: 14/186,272

(22) Filed: Feb. 21, 2014

(51) Int. Cl. A01G 27/00

(52) U.S. Cl. CPC A01G 27/006

(57) ABSTRACT

An apparatus for providing fluid to a container bearing a plant, tree, shrub, fern or other vegetation wherein the apparatus comprises a vessel having at least one exterior surface sufficiently strong enough to withstand the weight of the container, a fluid reservoir and pump concealed within the vessel, a pump concealed within the vessel making fluid contact with the fluid reservoir via a pump intake and a pressure switch or moisture switch operatively connected to the pump also concealed within the vessel and methods for providing fluid from the fluid reservoir to the container thereof.

### FIELD OF TECHNOLOGY

The following relates to an automated apparatus and method for watering plants, trees and other vegetation, and more specifically to embodiments of an automated watering system that detects liquid levels being supplied to the vegetation and resupplies a liquid automatically when liquid levels reach a minimally acceptable level.

### BACKGROUND

Plants, trees and other vegetation planted, grown, and cared for by individuals require frequent maintenance, including watering or replacement of liquid residing in the containers holding the vegetation. Often, the liquid medium present in the containers may have variable rates of absorption or evaporation. This presents a challenge to individuals caring for the vegetation because consistently maintaining plant life can be demanding and viewed as a chore. Often individuals may forget to replenish the fluid medium, particularly when the medium requires replenishment constantly or at variable intervals. Special containers are commercially available which provide liquid replenishment; however, these commercially available containers are inconsistent and have a tendency to malfunction. The currently available containers operate using capillary action, or employ a liquid detection method that utilizes floats to trigger a switch. Often times, containers relying on floats to activate a switch malfunction, leaving the switch either stuck in a closed or open position. This results in flooding or the inability to replenish the liquid reservoir of the containers holding the vegetation.

Commercially available watering systems are also visually obtrusive and difficult to conceal. The watering systems currently available are unable to provide a slim, sleek, less noticeable appearance, while still managing to contain all components into a single unit and maintain a relatively large liquid reservoir compared with the needs of the vegetation being cared for. When a pumping means is employed, they are maintained separately from the reservoir, thus being even more obtrusive and an eyesore. Currently available watering systems also sacrifice compactness for large reservoirs, often using hideous methods to conceal the pumps and oversized reservoirs. One common approach for a Christmas tree watering systems is to disguise the watering system as a decorative object or festive package. However, these attempts to disguise the system are still noticeable and obtrusive as well as incapable of being used all year around without being out of season and therefore drawing even more attention to the apparatus.

Thus, a need exists for a reliable automated system capable of replenishing fluid to vegetation having a system that is a compact, less noticeable, and may be used all year around with any currently existing decorative container, while still maintaining a reservoir that is relatively large in comparison with the container's size.

### SUMMARY

A first embodiment of this disclosure relates generally to an apparatus for providing fluid to a container comprising a vessel having at least one exterior surface, the vessel configured to support the container, a fluid reservoir located within the vessel, a pump located within the vessel, making operative contact with the fluid reservoir; and a switch operatively connected to the pump located within the vessel.

A second embodiment of this disclosure relates generally to a method for automatically delivering a stream of fluid to a receptacle containing vegetation comprising the steps of providing a vessel configured to accommodate a fluid reservoir, a switch and a pump, wherein the switch is at least one of a pressure switch and a moisture switch, placing a sensor operatively connected to the switch inside the receptacle, wherein the sensor is a moisture sensor or a pressure sensor, attaching the switch to the pump, initiating the pump when either the pressure sensor drops to a predetermined pressure or the moisture sensor drops to a predetermined moisture, pumping the stream of fluid from a reservoir to the receptacle and terminating the initiation of the pump when pressure sensor or moisture sensor in the receptacle re-exceeds the predetermined level.

### BRIEF DESCRIPTION OF THE DRAWINGS

Some of the embodiments will be described in detail, with reference to the following figures, wherein like designations denote like members, wherein:

FIG. 1 depicts a top-view of an embodiment of an automated watering system;

FIG. 2a depicts a cross-sectional view of the embodiment of FIG. 1;

FIG. 2b depicts a perspective view of the embodiment of FIG. 1;

FIG. 3 depicts a cross-sectional view of an embodiment of the automated watering system of FIG. 1 being applied to vegetation;

FIG. 4 depicts a top-view of an alternative embodiment of an automated watering system;

FIG. 5a depicts a cross-sectional view of the alternative embodiment depicted in FIG. 4;

FIG. 5b depicts a perspective view of the alternative embodiment depicted in FIG. 4; and

FIG. 6 depicts a cross-sectional view of another alternative embodiment of the automated watering system.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, colors thereof, the relative arrangement thereof, etc., and are disclosed simply as an example of embodiments of the present disclosure. The figures, in some cases, show overlapping components in assembly. The overlap is illustrative of an interference fit in which the components flex or otherwise accommodate the assembly of the components.

As a preface to the detailed description, it should be noted that, as used in this specification and the appended claims, the singular forms “a”, “an” and “the” include plural referents, unless the context clearly dictates otherwise.

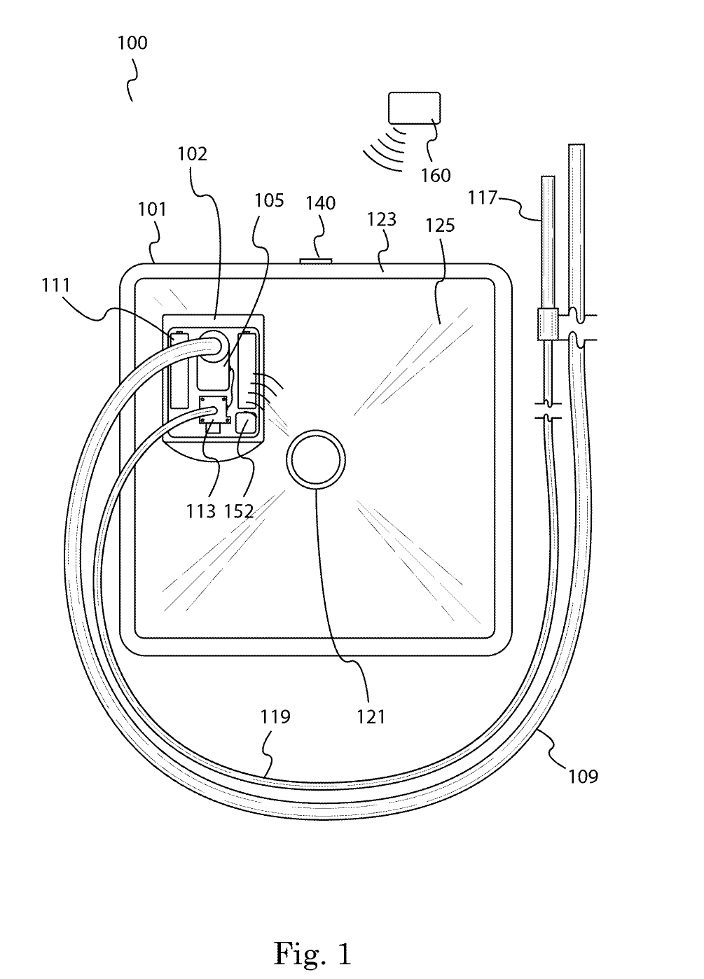

Referring to the drawings, FIG. 1 depicts an embodiment of an automated watering system 100, which may be used for providing water, nutrient enhanced liquid, liquid containing one or more macronutrients and/or micronutrients, liquid containing chemicals, such as chemical fertilizers with or without an additional liquid, liquid containing organic or inorganic materials, or any other liquid capable of maintaining, enriching, growing, sustaining, etc. the life of a plant, tree, shrub, fern, cactus, or any other form of vegetation 190 that may be a part of Kingdom Plantae. The watering system 100 may be fully automatic and maintenance free, except for the occasional user interaction of refilling the fluid reservoir 103. Embodiments of the automated system 100 may utilize auto-refilling methods for refilling the reservoir 103. For example, a separate water source may be placed in communication with the reservoir 103 having a switch or sensor in communication with a pump to monitor and respond to a need for refilling the reservoir 103. In some embodiments, a separate fluid supply source may be placed in communication with one or more systems 100 and resupply each reservoir independently as the fluid reservoir becomes depleted.

In some embodiments, the automated watering system 100 may be used to supply liquid 170 to plants kept inside a building such as an office, business, home, apartment, store or restaurant. In another embodiment, the automated watering system 100 may be used to supply liquid 170 to outdoor plant-life and vegetation 190 maintained by the user. Embodiments of the automated watering system 100 may be used all year around to maintain the vegetation 190, or the automated watering system 100 may be used seasonally. For example, the automated watering system may be used to maintain the life of plants and other vegetation 190 brought indoors during the cold winter months, or in another example, the system 100 may be employed to provide liquid to seasonal vegetation 190 such as a Christmas tree. In yet another example, the system 100 may be used for providing the fluid 170 to plants while the user is absent from the location containing the vegetation 190 for a prolonged period of time. The automated watering system 100 may not be limited to household or indoor vegetation 190, but may also be implemented to supply a liquid for maintaining the life of vegetation 190 in an indoor or outdoor garden.

The automated watering system 100 may include a vessel 101, which may house all the components of the system 100. The vessel 101 may have at least one exterior surface 125 that may act as a base or support surface for setting one or more containers or receptacles 150 on the vessel 101. The at least one exterior surface 125 acting as a base may have a slightly recessed portion capable of receiving the container or receptacle and for providing extra stability to the container sitting on the base of the vessel 101. In other words, the at least one exterior surface 125 may be conformal to a container 150 placed directly on the vessel 101. Embodiments of the at least one surface may also have a rigidity or hardness factor to remain stiff/rigid or substantially stiff/rigid so as to resist substantial deformation when a container 150 is placed on the vessel 101. Embodiments of the vessel 101 may be a reservoir, a container, a tank, a basin, or any device configured to receive and store, at least temporarily, an amount of fluid.

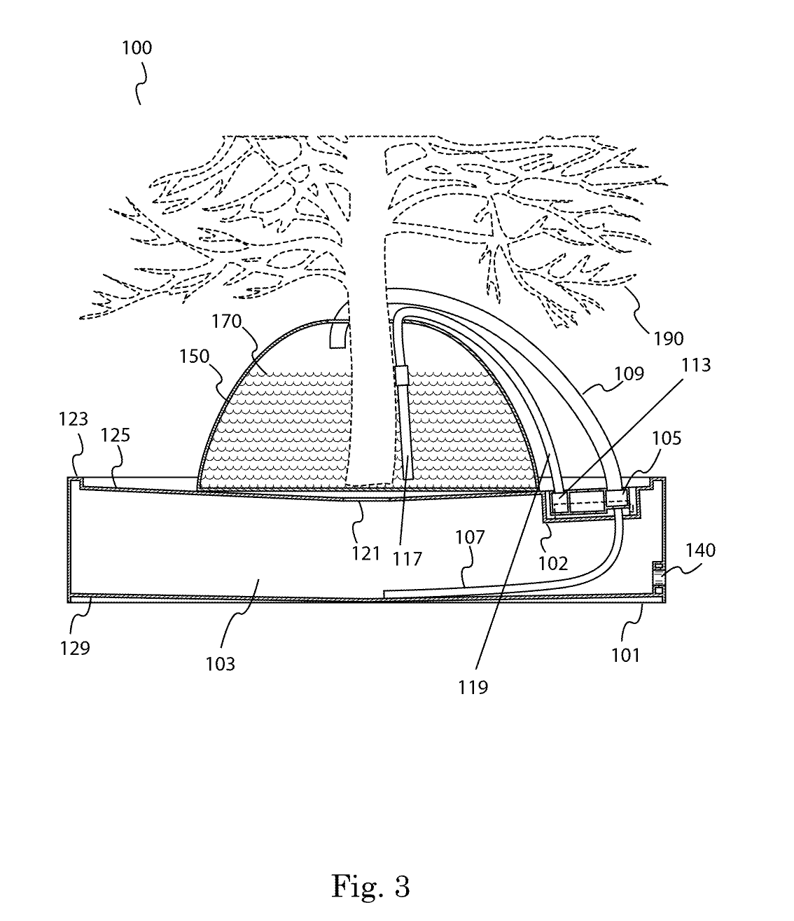

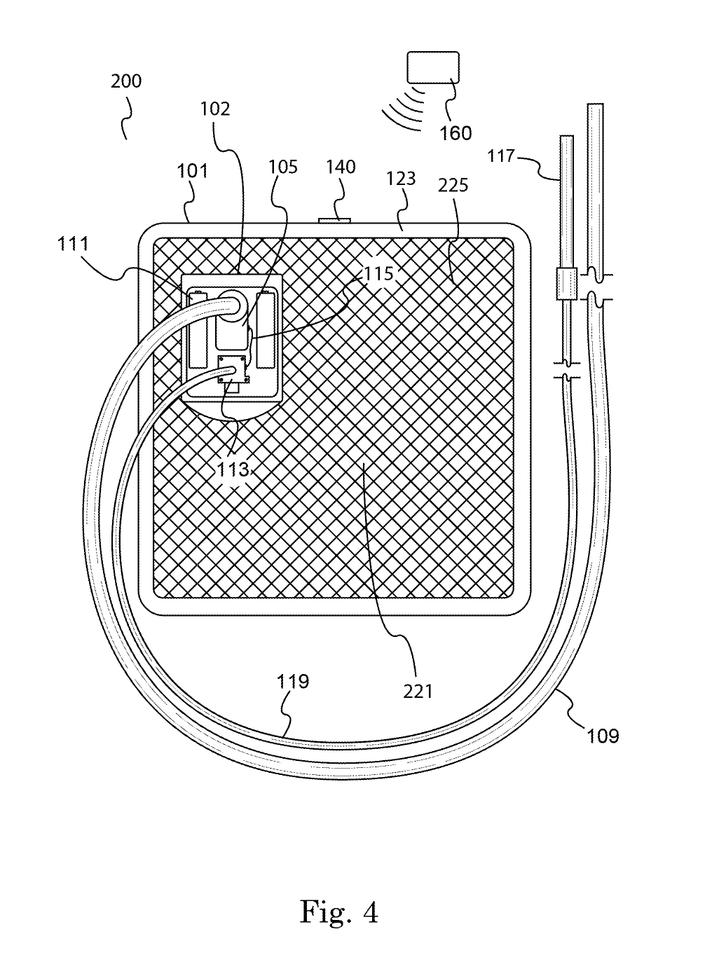

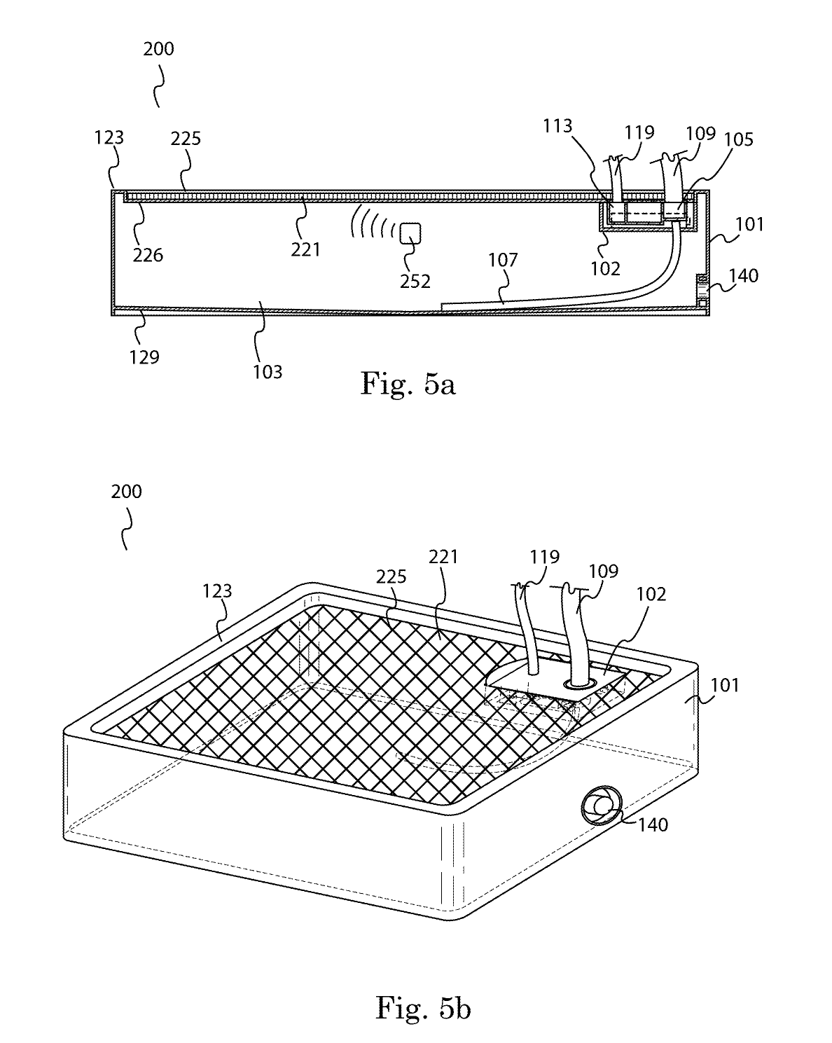

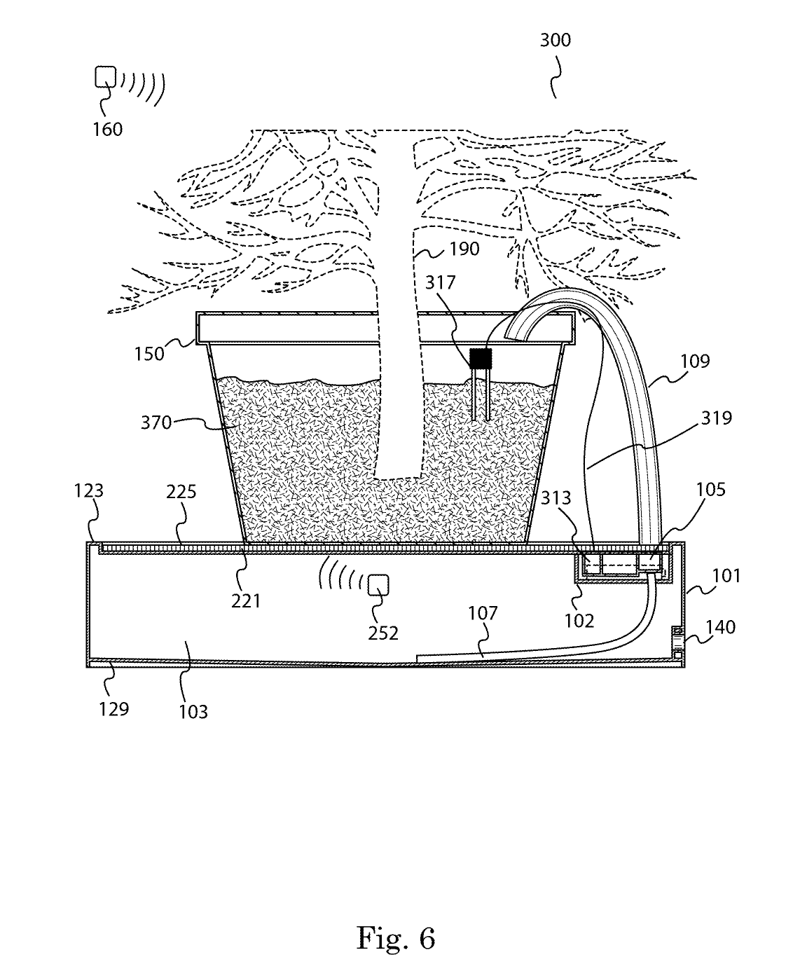

With additional reference to FIG. 3, embodiments of vessel 101 may be configured to support, receive, accept, hold, engage, etc. a container or receptacle 150. Embodiments of a container or receptacle 150 may be any device capable of holding, containing, supporting, and the like, vegetation such as plants, trees, ferns, shrubs and other vegetation 190 or other plant life of Kingdom Plantae. Examples of a container 150 may include plastic, terracotta, ceramic or concrete pots, stone containers, baskets, polystyrene or wooden planter boxes, cache pots, growing bags, tree stands, including Christmas tree stands, upside down grow bags, and even unique and makeshift containers such as washtubs or cans. In an exemplary embodiment, the automated watering system 100 does not include a built in container 150, rather it may accommodate any size or shape container 150 without having to conform the selected container to the shape of the recessed portion of the vessel. In other words, the vessel 101 may be structurally independent of the container 150, comprising two separate components of the automated watering system 100. A built in container may provide some disadvantages because it may prevent a user from using a container of their choice. In some instances, users may coordinate the appearance of the container to the décor of the location wherein the container 150 resides. Other users may prefer their own containers 150 because of the sentimental value they have. A built in container may limit the user's choice or freedom to select a container 150 they may already have on hand or prefer over a built in container. The system 100 may be used with any existing container 150 without having to perform modifications to the container 150. In an alternative embodiment, a container or receptacle 150 may be built into the vessel 101. For example, the vessel may include a pot for receiving a potted plant or a Christmas tree stand for receiving a Christmas tree. Embodiments of the container 150 and the vessel 101 may be structurally integral, and may be formed from the same material using known manufacturing methods.

The vessel 101, wherein the container 150 may sit upon, may be any shape, size or color. For example, in one embodiment, the vessel 101 may be a cube or cuboid while in an alternative embodiment, the vessel may be in the shape of a cylinder or elongated cylinder. While the vessel 101 may be any size or shape, some embodiments may be thin and sleek to reduce visibility and minimize attention to the system's 100 presence. For example, in one embodiment, the vessel 101 being used to hold a standard sized Christmas tree may have a height of less than three inches. In other embodiments, such as wherein the automated watering system 100 is being used for household plants, the vessel 101 may be even thinner and more discrete. For instance, the vessel 101 may be less than three inches, less than two inches or even less than one inch in height, depending on the size and consumption needs of the vegetation 190.

In other instances where a relatively large container 150 is used, the vessel 101 may be greater than three inches in height. Alternatively, the vessel may remain thin, for example approximately 1-2 inches, but maintain a length and width necessary to increase the total volume for storing an appropriate amount of fluid 170. In other embodiments, the user may select a vessel 101 of the appropriate size and height based on their personal preferences and liquid consumption needs of the vegetation 190 being supplied the liquid 170.

In some embodiments, one or more systems 100 may be placed in communication with one another. For example, one or more automated systems may independently support and provide fluid to the respective vegetation associated with each system. However in some embodiments, the fluid reservoir of each system may be in fluid communication with one another, allowing each system to draw or share fluid between each independent reservoir. In another embodiment, the system may be scaled using more than one vessel to accommodate a larger or more fluid demanding vegetation. For example, the one or more vessels may snap or combine together to form a larger exterior surface that may act as a support or base. The fluid reservoirs of each vessel combined together may also share or combine the resources of each independent fluid reservoirs in an effort to support the larger or more demanding vegetation.

The vessel 101 may be constructed out of any strong and rigid material capable of withstanding the force being placed on the exterior surface 125 by the container 150 sitting on top of the vessel 101. For example, the vessel 101 may be constructed out of various plastics, resins, composites, wood, or metal. The materials may include polycarbonate, polyurethanes, polyesters, epoxy resins, phenolic resins, polyethylene, polypropylene, polyvinyl chloride, polyethylene terephthalate, low density polyethylene, high-density polyethylene, polystyrene, polylactide, steel, aluminum, tin, titanium or any other substance capable of taking a rigid shape, that is able to provide support for the container 150.

In some embodiments, the vessel 101 may be visually customizable by the user. A user may choose to decorate or colorize the vessel's exterior in an attempt to camouflage or coordinate the vessel 101 to the vessel's location. For example, the vessel 101 may be constructed out of a material that may be dyed certain colors. In other embodiments, the vessel may be constructed out of or laminated with a material that may permit the user to design or decorate the exterior surfaces of the vessel. In one embodiment, the vessel may be laminated with a dry erase board material such as melamine, painted steel or aluminum, hard-coat laminate, porcelain, enamel or polyethylene terephthalate on steel, which allows for markers to be used and/or reused on the surface. In another embodiment, the surface of the vessel may be coated or laminated with a chalk board material. In an alternative embodiment, the vessel 101 may be constructed out of or laminated with a material that may allow the user to paint or colorize the exterior surfaces themselves. In still yet additional embodiments, the vessel 100 may be further concealed or decorated using a skirt, matting or other covering that may be placed over the vessel 101.

The vessel 101 may further include one or more additional features providing easier transportation and movement of the vessel. For example, in some embodiments, an exterior surface of vessel 101 may include one or more handles or hand holds, along or protruding from, at least one exterior surface of the vessel. The handles or hand holds may provide a section allowing the user a space to grip and/or lift the vessel 101. In another embodiment, the vessel 101 may contain wheels along the bottom surface of the vessel 101. The wheels may also make it easier to transport larger containers 150 between two points or to transport the reservoir 103 to the location of the containers 150. The wheels may provide assistance to individuals who may be elderly, less physically fit or handicapped.

In some embodiments, the vessel 101 may further comprise one or more compartments or chambers 102. The compartments/chambers 102 may store, or conceal various components of the automated watering system 100 from being directly viewed from the exterior of the vessel. The one or more compartments 102 may be covered or sealed in any fashion that may prevent the contents of the chamber from being visible. The cover or seal may be removable, thus providing access to the compartments for modification and replacement of components present in the compartments therein. For example, the compartments may be covered with a cap, hatch, hinged door, latching cover or fasten-able plate. Other embodiments may be fitted with a threaded screw cap, snap-in-place in cover, tongue and groove mechanism, a removable plate, hinged plate or any other type of cover that may be used to conceal the entrance to the one or more compartments that may still be accessible to the user.

In some embodiments, vessel 101 of the system 100 may be a unitary enclosed vessel. In other embodiments 200, the vessel 101 may detach into 2 or more segments. For example, an external surface 225 of the vessel may be detachable from the vessel 101 and upon detaching, the internal compartments of the vessel may be exposed in their compartments underneath the external surface. This detached embodiment 200 may be useful for easy cleaning and maintenance of the vessel 101 and system 200. In other embodiments, an exterior surface 102 may pivot along an axis or hinge to lift and separate from one vertical exterior surface of the vessel, while the top of the vessel remains connected at a pivot point, wherein the top portion acts as a lid or cover to the compartments below.

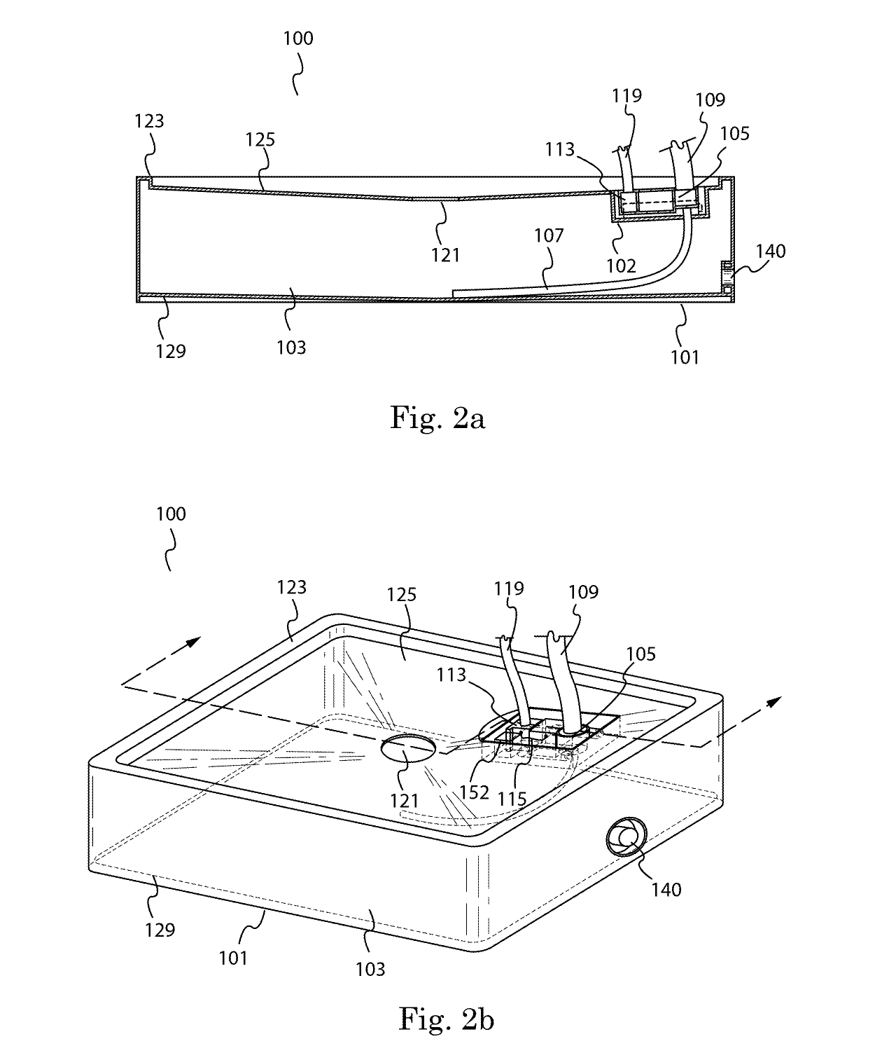

Referring still to FIGS. 1-3, embodiments of the vessel 101 may include a fluid reservoir 103 compartment concealed within the vessel 101. The reservoir 103 may store, receive, accept, contain, and/or collect the liquid 170 being supplied from the automated watering system 100 to the container 150 holding the vegetation 190. The reservoir 103 may vary with the size of the vessel. For instance, in some embodiments, the reservoir 103 may hold less than 5 oz, less than 8 oz., less than 16 oz, less 32 oz. less than 64 oz or less than 128 oz. of fluid 170, while in other embodiments, the vessel 101 may hold between 1-12 gallons of fluid 170, while in some instances, the fluid reservoir 103 may be scaled up to hold more than 12 gallons of fluid 170. The reservoir 103 may hold any liquid 170 that may be used to maintain the plant-life of Kingdom Plantae. Examples of liquids 170 may include water, mixtures or solutions including various nutrients known in the art to sustain, maintain, or grow the life of the vegetation 190.

The reservoir 103 of vessel 101, in some embodiments may include a sloped or ramped surface 129. The sloped or ramped surface 129 may direct, flow, or otherwise urge the liquid 170 residing in the reservoir 103 to a particular area of the reservoir 103. This may maximize the amount of liquid 170 that may be removed from the reservoir 103 and supplied to the container 150. For example, in one embodiment, the sloped or ramped surface 129 may feed the fluid toward an intake 107 of a pump 105. By directing the liquid to the intake 107 of the pump 105, this may maximize the amount of liquid removed by the pump 105 and sent to the container 150. The ramped surface 129 may reduce the amount of residual liquid residing in the reservoir 103, and may thus reduce the number of times a user may have to refill the reservoir 103, or instances where an automated system may need to pump new fluid in the reservoir 103.

In some embodiments, the reservoir 103 may include a sensor 152, 252 to detect a level of fluid remaining in the reservoir 103. The sensor 152, 252 may be any type of sensor that may measure fluid levels, including a wireless sensor 152, 252. The sensor 152, 252 may include a wireless transmitter such as a radio or Bluetooth® transmitter. In other embodiments, the sensor may be networked to a computer network via Wi-Fi, or a cellular network, such as 3G, 4G, or LTE, and linked with a software program running on a smartphone. The sensor 152, 252 may be paired with a receiver 160 capable of receiving signals from the sensor 152, 252. The sensor 152, 252 may broadcast a signal to the receiver 160 based on the fluid levels of the reservoir. When the fluid levels of the reservoir become depleted, the receiver 160 may emit an auditory signal, visual signal or a combination of signals thereof

Embodiments of the receiver 160 may take an infinite number of shapes and sizes. For example, in one embodiment, the receiver 160 may appear to be a household item, knick knack or figurine. In another embodiment, the receiver 160 may be connected to a nearby lamp or light, while in alternative embodiments, the receiver 160 may be a computing device such as a desktop computer, laptop, tablet PC, iPad, network enabled mp3 player such as an iPod, smartphone or cellular phone. In yet another alternative embodiment, the receiver may be a seasonal item or decorative item accompanying the vegetation 190 in the container 150. For example, in an embodiment where the system 100 is used to provide fluid 170 to a Christmas tree or other holiday plant or tree, the receiver 160 may take the shape of an ornament placed on the tree itself, whereas in potted plant embodiments 300, the receiver 160 may take the form of a gnome or flamingo, or other distinctive objects/animals.

The sensor 152, 252 may be placed in one or more locations within the system 100. For example, in one embodiment, the sensor 252 may be submerged in fluid 170, to create an electrical circuit. When the fluid recedes, the electrical circuit may be broken, thus breaking the signal to a receiver. When the signal to the receiver 160 is broken, it may initiate a signaling response that alerts the user of the low fluid level in the reservoir 103. In another embodiment, the sensor 152 may reside in one of the compartments 102 with the rest of the components of the system. Whereas in other embodiments, the sensor 152, 252 may simply reside above the fluid level of reservoir 103. The sensor 152, 252 may detect the height of the water using ultrasound, radiowaves, radar or any other type of wave to measure the height of the fluid levels. As the height of the fluid decreases beyond a certain measurable distance, the sensor may send a signal to the receiver.

The signal being transmitted to the receiver 160 may be any signaling system known in the art. For example, the signal may be broadcasted using a standard radio frequency between 3 kHz and 300 GHz. Some common standards of signal transmission may include a transmission between 150-433 MHz or an IEEE 802.11a, 802.11b, 802.11g or 802.11n Wi-Fi signal broadcasting between approximately 1.5-2.4 GHz. In alternative embodiments, the sensor 152, 252 may include other means of detecting the fluid levels, such as through the use of a radar level sensor, compact bubbler sensor, pressure level sensor, or a float based sensor.

Upon receiving the signal from one or more sensors 152, 252 the receiver 160 may provide an audio, visual or a combination of signals thereof to alert the user that the fluid level in the reservoir 103 is below a predetermined level. For example, the sensor′ signal may initiate the receiver 160 to turn on a signal light or flash signal lights, play a sound or alarm, send a message to a computing device such as an SMS text message, email or other network based alert. The one or more sensors in the fluid reservoir may provide the receiver 160 with one or more signals depending on the amount of fluid remaining in the reservoir. The receiver may subsequently provide different signals alerting the user of the various conditions of the fluid reservoir at various times. For example, the receiver 160 may alert the user when the fluid reservoir 103 is at the halfway mark, one-quarter mark and when the fluid reservoir is completely empty. In another embodiment, the receiver may alert the user when the reservoir contains an amount that will fill the container one last time. The various alert types, and parameters for alerting the user may be customized by the user based on their preferences. A user who wants more advanced warning may adjust the one or more sensors 152, 252 to provide more frequent signals to the receiver regarding the amount of fluid remaining, whereas another user may set the one or more sensors 152, 252 to send a signal to the receiver only when the reservoir is completely depleted.

Referring still to the drawings, in some embodiments of vessel 101, the vessel 101 may further comprise a pump compartment 102. The pump compartment 102 may hold a pump 105, concealed within the vessel 101. In some embodiments, the pump 105 may be outfitted with an intake 107 and an output hose 109. The intake 107 may extend between one or more compartments. For example, the intake 107 may extend from the pumping compartment 102 to the fluid reservoir 103, making operative contact with the fluid reservoir 103 to draw out fluid 170 when the pump is initiated via an opening or port between the pumping compartment and the fluid reservoir 103. When the pump 105 is initiated, it may draw fluid 170 from the reservoir 103 and provide the stream through at least one output hose 109 to a final destination such as one or more containers 150.

The output hose 109 may use any form of flexible or rigid hose, tubing or pipes having a hallow cross section capable of guiding fluid to the container 150. The pump 105 may be any type of pump capable of displacing fluid 170 from the reservoir 103 and transporting the fluid 170 through the output hose 109 to the container 150. In some embodiments, pump 105 may be a positive displacement pump, impulse pump, velocity pump, gravity pump or valve-less pump. Examples of pumps may include, but are not limited to an electric pump, submersible pump, centrifugal pump, roto-dynamic, rotary-type pump, reciprocating pump, linear-type pump, gear pumps, screw pumps, rotary vane pumps, plunger pumps, diaphragm pumps, piston pumps, hydraulic pumps, lobe pump, rotoliptic pump, radial flow pump, mixed flow pump or any other pump known in the art to displace fluid from one location to another.

Embodiments of vessel 101 may further include pressure fitted slots along the exterior of the vessel. These slots may be capable of receiving the pressure hose 119, output hose 109 or any other hoses may be placed and securely fitted for easy movement, transportation or storage.

In some embodiments, the pump 105 may be connected to a power source or power supply 111. The power source 111 may be any known type of power source capable of powering a pump 105. Examples of a power source 111 may include a battery, rechargeable battery, AC outlet, generator, and/or solar panels, to name a few. In some embodiments, one or more power supplies may be used. One power source 111 may provide a primary source of power to the pump 105 while a secondary power source may take over for the primary source if the primary source becomes exhausted or discontinued. For example, the system 100 may include a solar panel to provide electricity to operate the pump 105. However, if the solar panel malfunctions, an optional battery may supply the requisite electricity to operate the pump 105 until the solar panel is repaired.

In an exemplary embodiment 100, the automated watering system may include a battery powered pump 105. The battery powered pump 105 may reduce hazards that may exist when a power supply 111 may extend beyond the exterior of the vessel 101. For example, when the pump 105 is plugged in via an electrical cord, the cord, extending from the vessel 101 to the outlet, may present a tripping hazard and/or may present a hazard for electrical shock. Furthermore in an embodiment that utilizes a battery or other wireless power source, the automated watering system 100 may be placed in any location, including tables or countertops without having to be tethered to any electrical outlet or other AC power source. Using a wireless power source may allow for the system 100 to be easily moved from one location to the next without having to re-run a power supply line.

In some embodiments, the power source 111 may reside within the pumping compartment 102 alongside the pump 105. In an alternative embodiment, the vessel 101 may include a power source compartment that may separate the power source from the pumping compartment 102 and the reservoir compartment 103.

In an embodiment where the power source may have to face the exterior of vessel, such as in the case of a solar panel power supply, the power supply may be recessed into one of the exterior surfaces 125 of the vessel 101. The solar panel power supply may snap into a slot capable of receiving the power source 111 or be embedded into a portion of the exterior surface 125. The solar panel once snapped in place or embedded, may be flush with the exterior surface of the vessel 101.

In some embodiments, the pumping compartment 102 of vessel 101 may further comprise a switch 113 operably connected to the pump 105. The switch may be any type of electrical component that can break the electrical circuit of the pump 105, thus initiating or preventing the initiation of the pump 105 under certain conditions when the switch 113 is placed in the open or closed configuration. The switch 113 may be connected to a sensor 117. The sensor 117 may be placed in the container 150 and used to determine either the fluid level 170 or the moisture content of the container 150. In some embodiments wherein the container comprises vegetation sitting in liquid 170, the sensor 117 may be a pressure sensor 117. In an alternative embodiment wherein the container includes vegetation planted in soil 370, the sensor may be a humidity or moisture sensor 317.

As depicted in the embodiment of FIG. 1, the pressure sensor 117 may be connected to the pressure switch 113 via a pressure hose 119. The pressure switch 113 may reside in a separate compartment from the fluid reservoir 103 such as the pump compartment 102. In an alternative embodiment the pressure switch may reside in a separate compartment with the battery, or an independent compartment of its own. The pressure sensor 117 may detect the amount of fluid pressure in the container 150. Once the vegetation in the container 150 consumes a specified amount of fluid, the fluid pressure may drop below a predetermined pressure, activating the pressure switch 113 operatively connected to the pump 105, placing the pressure switch into the closed position. While the pressure switch 113 is in the closed position, the circuit to the pump 105 may be completed, thus providing power from the power source 111 to initiate the pump 105. The pump 105 once activated, may begin displacing fluid 170 from the reservoir 103, via the intake 107, and emitting the fluid 170 as a stream toward the container 150 via the output hose 109. As the fluid level 170 in the container 150 begins to rise upon the receipt of fluid 170 from the output hose 109, pressure begins to build up in the pressure sensor 117. As the pressure reaches the predetermined level, the switch 113 is once again placed in the open configuration, opening the circuit between the pump105 and the power source 111, disengaging the pump 105, and thus stopping the disposition of fluid from the reservoir 103 to the container 150.

In an alternative embodiment 300, the pressure sensor 117 may be replaced with a moisture sensor 317. In the exemplary embodiment, a moisture sensor 317 may be used when the container includes vegetation planted in dirt or soil 370. The moisture sensor 317 may be operably connected to a humidity or moisture switch 313. As the moisture or humidity in the container 150 drops below a specific level, such as when the soil 370 becomes drier, the moisture sensor 317 may activate the moisture switch 313 operably connected to the pump 105, which may close the circuit between the power source 111 and the pump 105, in turn initiating the pump 105 as described above. As the liquid 170 from the reservoir 103 is displaced into the container 150, the moisture levels may rise and once the moisture levels reach a pre-selected level, the switch 313 may open the circuit between the pump 105 once again, ceasing the pump's displacement of fluid.

In some embodiments of vessel 101, the vessel may include a fluid recirculation system 121 operably connected to the fluid reservoir 103. The fluid recirculation system 121 may incorporate any means for collecting and returning fluid 170 in excess of the amount able to be held by the container 150 and return the fluid back to the fluid reservoir 103. The fluid recirculation system 121 may prevent flooding in an instance wherein a pump 105 may malfunction or overfill the container 150. For example, the switch 113, 313 in some instances may malfunction and remain in the closed position after extensive use, providing continuous fluid displacement by the pump from the reservoir 103 to the container 150. The reservoir 103 may be larger than the amount of fluid 170 the container 150 may hold, thus the recirculation system 121 may catch the overflowing fluid 170 as it rises higher than the boundaries of the container 150. This may prevent the fluid 170 from overflowing the sides of the vessel 101 and instead return the fluid 170 to the reservoir 103 where the fluid 170 may continue to cycle between the reservoir 103 and container 150 until either the user interjects, the power source 111 fails or the pump 105 ceases operation.

In one embodiment, the fluid recirculation system 121 may include one or more ports, grating, mesh or membrane capable of allowing fluid to flow through. The ports 121, grating 221 or mesh may be positioned along the exterior surface 125, 225 of the vessel and into the interior of the reservoir compartment 103. The excess fluid landing on the exterior surface 125, 225 may enter the fluid recirculation system 121, 221 by entering the ports 121, grating 221, mesh or membrane and flow back into the reservoir 103. In some embodiments, the exterior surface 125, 225 of the vessel may be pitched at an angle to force the fluid being returned to the reservoir 103 to flow in a certain direction. For example, in one embodiment, a single port 121 may be located in the center of an exterior surface 125, or multiple ports may be dispersed across the exterior surface 125. The exterior surface 125 may be sloped to form a slight conical shape wherein the fluid may flow onto the exterior surface at any point and be directed toward the one or more ports 121 connecting the sloped conical exterior surface to the fluid reservoir 103.

In an alternative embodiment 200, the top exterior surface 225 may be grating 221 that allows fluid to pass through exterior surface 225 to the reservoir 103 below. In other embodiments, the ports, grating mesh or membrane may be a separable or removable surface from the rest of the vessel. For example, the top exterior surface 225 may be a grate or screen placed on top of the exterior walls or a recessed interior wall of the vessel 101. Upon removing the grating 225, the remaining compartments, including the fluid reservoir and pumping compartment 102 may be exposed and become easily accessible. In some embodiments, the removable portion 225 of the fluid recirculation system may nestle within the interior walls of the vessel, such as through a notch or groove capable of receiving the grated exterior surface 225. In some embodiments the removable portion may be held in place by the friction between the perimeter of the removable portion and the interior walls of the vessel. In an alternative embodiment, the vessel may have a ridge or lipped surface 226 along the perimeter of the interior perimeter of the vessel, allowing at least a portion of removable surface 225 to rest on top thereof. In yet another embodiment, the separable portions of the vessel may be latched or locked together in an effort to provide extra security against detachment.

In some embodiments, the fluid recirculation system 121, 221 may include one or more channels that extend along the exterior surface 125 of the vessel 101 or in some embodiments, along the perimeter of the vessel. Inside the valley of the one or more channels, one or more ports or access points may exist that allow for the fluid to return to the reservoir 103 below. In some embodiments, the exterior surface 125 of the vessel 101 and/or the channels themselves may be pitched or sloped toward the direction of the ports or access points.

In some embodiments, the fluid recirculation system 121, 221 may also act as a means for replenishing the fluid supply in the reservoir 103. A user may resupply the fluid reservoir by pouring new fluid into the recirculation system 121, 221. An embodiment wherein the exterior surface 125 is slightly pitched or sloped, offers the user an advantage of placing new fluid into the recirculation system from any point on the exterior surface because all fluid placed on the exterior surface will flow toward and enter the reservoir.

Some embodiments of the fluid recirculation system 121, 221 may further include a raised portion 123 of the vessel 101 along the perimeter of the vessel, which may act as a fence, barrier or form a fluid collection tray. In some embodiments, the raised portion 123 may be raised 90 degrees, while in other embodiments, the raised portions may be angled larger or smaller than 90 degrees. The raised portion of the vessel 123 along the perimeter may prevent fluid from spilling over the sides of the vessel 101 in the event that the excess fluid or fluid resupply flow rate is greater than the rate at which the fluid enters the recirculation system 121, 221 and returns to the fluid reservoir. The raised portion of the vessel 123 along the perimeter of the vessel may further catch excess fluid in the event that the user has overfilled the reservoir 103. As the reservoir contents are displaced to container 150, as needed, the overfilled reservoir may eventually have space to accept the excess fluid sitting on the exterior surface 125, 225 of the vessel, thus returning the fluid 170 back to the reservoir.

In some embodiments, the recirculation system 121, 221 may further include a removable plug, cap or cover. The removable plug, cap or cover may be inserted or removed as necessary by the user, into or over, the ports, drains, mesh, grating and entryways from the recirculation system 121, 221 into the reservoir 103. For example, a user may want to transport the vessel 101 without having to worry about the contents of the reservoir being spilled via an open recirculation system 121, 221. The user may plug, cover or close the entryways into the recirculation system 121 to prevent fluid in the reservoir 103 from spilling during the transportation of vessel 101.

In some embodiments, the vessel 101 may include one or more ports or drains 140 along one or more exterior surfaces of the vessel 101 for filling or removing the reservoir's 103 contents in a manner separate from the fluid recirculation system121, 221. The one or more ports or drains 140 may include for example removable covers, caps, screw caps, fittings, seals, grommets, plugs, hatches, holes or channels which extend between the reservoir 103 and an exterior surface of the vessel. In one embodiment, a drain 140 may be located on an exterior surface adjacent to the surface acting as a base surface providing support to the container. In the exemplary embodiment, the drain 140 may be located towards the bottom of the exterior surface to ensure that as much fluid is removed from the reservoir 103 as possible once the drain 140 is opened. In another embodiment, the drain 140 may be located on the bottom surface of the vessel 101. Embodiments of the ports for filling the reservoir 103 may also be located along any exterior surface of the vessel. The opening of the filling port may be large enough to accommodate various spouts of various fluid holding canisters, watering cans, funnels, hoses, tubing or other means for administering fluid into a reservoir in a rapid fashion.

In some embodiments, the vessel may be fitted for outdoor use. In one or more embodiments, the vessel may be equipped with a filling port on the top facing exterior surface 125. For example, in some embodiments, such as when the vessel 101 is used for outdoor vegetation, it may be beneficial to bury the vessel 101 in the ground. However, since the vessel may be refilled periodically, a filling port accessible from the surface of the ground may provide access to the reservoir 103, thus replenishing its contents without having to unbury the vessel 101.

In one embodiment of a method for automatically delivering a stream of fluid from the fluid reservoir 103 to a container or receptacle 150 holding a plant, tree or other vegetation 190, the method may comprise the steps of providing a vessel 101 configured to accommodate one or more components including a fluid reservoir 103, a switch 113 and a pump 105. The switch 113 may be pressure switch 113 or a moisture switch 313 and the decision of which to use may vary based on the contents of the receptacle 150. The method for providing a stream of fluid to a container may further comprise the step of placing a sensor 117 operatively connected to the switch 113 inside the receptacle. The sensor 113 may be a pressure sensor 117 or a moisture sensor 317. The appropriate sensor may be selected accordingly based on the type of switch 113, 313 being used. For example, if a pressure switch 113 is being used for one embodiment of this method, then a pressure sensor 117 may be selected. Conversely, where a moisture switch 313 is employed, a moisture or humidity sensor 317 may be used. Subsequent steps may include attaching the switch 113, 313 to the pump 105. This may be completed by wiring 115 the switch 113 to power and ground leads of the pump 105, thus when the switch is open, the pump cannot initiate because the pump 105 may be failing to receive the power from the power supply 111.

The method for delivering a stream of fluid to a receptacle 150 containing vegetation 190 may further comprise the steps of initiating the pump 105 when either the selected pressure sensor 117 or moisture sensor 317 drops below a predetermined level of moisture or pressure, followed by pumping the stream of fluid from the reservoir 103 to the receptacle 150 and terminating the initiation of the pump 150 when the pressure 117 or moisture 317 sensor rises above the predetermined level. In some embodiments, the method of delivering a stream of fluid may further comprise the steps of recirculating excess fluid residing on the exterior surface 125, 225 of the vessel back into the fluid reservoir 103 via the fluid recirculation system 121, 221 and providing an audio signal, visual signal or a combination of signals thereof alerting the user when the fluid reservoir contains a fluid level that is less than the desired level of fluid determined by the user. In some instances, the user may want to be alerted when the fluid level is completely depleted. In other instance a user may want to be alerted when there is less than ½, less than ⅓, less than ¼, less than ⅛ and/or less than 1/16 of the remaining fluid available in the reservoir 103.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

We claim:

1. An apparatus for providing fluid to a container comprising:
a vessel having at least one exterior surface, the vessel configured to support the container;
a fluid reservoir located within the vessel;
a pump located within the vessel, making operative contact with the fluid reservoir; and
a switch operatively connected to the pump located within the vessel.

2. The apparatus of claim 1, wherein the vessel is constructed out of polyvinyl chloride, polypropylene, high-density polyethylene or polyethylene terephthalate.

3. The apparatus of claim 1, wherein the container is a Christmas tree stand.

4. The apparatus of claim 1, wherein the height of the vessel is approximately ≦3 inches.

5. The apparatus of claim 4, wherein the fluid reservoir contains between approximately 5-12 gallons of fluid.

6. The apparatus of claim 1, wherein the pump is an electric pump.

7. The apparatus of claim 6, wherein the electric pump is battery powered.

8. The apparatus of claim 1, further comprising a fluid recirculation system, operatively connected to the fluid reservoir.

9. The apparatus of claim 8, wherein the fluid recirculation system includes a sloped exterior surface and at least one port connecting the sloped exterior surface to the fluid reservoir.

10. The apparatus of claim 1, wherein the at least one exterior surface includes a raised portion of the perimeter.

11. The apparatus of claim 1, wherein the switch is at least one of a moisture switch and a pressure switch, the switch residing within a compartment within the vessel that is separate from the fluid reservoir.

12. The apparatus of claim 1, further comprising a wireless sensor detecting the fluid levels inside the fluid reservoir.

13. The apparatus of claim 12, wherein the wireless sensor broadcasts the fluid levels to a receiver, wherein the receiver emits an auditory signal, visual signal or a combination of signals thereof.

14. The apparatus of claim 13, wherein the receiver is a computing device or an ornament.

15. The apparatus of claim 1, wherein the vessel further comprises a pair of pressure fitted slots capable of receiving an output hose operably attached to the pump and a pressure hose operably attached to the pressure switch

16. A method for automatically delivering a stream of fluid to a receptacle containing vegetation comprising the steps of:
providing a vessel configured to accommodate a fluid reservoir, a switch and a pump, wherein the switch is at least one of a pressure switch and a moisture switch;
placing a sensor operatively connected to the switch inside the receptacle, wherein the sensor is a moisture sensor or a pressure sensor;
attaching the switch to the pump;
initiating the pump when either the pressure sensor drops to a predetermined pressure or the moisture sensor drops to a predetermined moisture;
pumping the stream of fluid from the fluid reservoir to the receptacle; and
terminating the initiation of the pump when the pressure sensor or the moisture sensor re-exceeds the predetermined level.

17. The method of claim 16, wherein the receptacle is a Christmas tree stand, the switch is the pressure switch and the sensor is the pressure sensor.

18. The method of claim 16, wherein the receptacle is a potted plant, the switch is the moisture switch and the sensor is the moisture sensor.

19. The method of claim 16 comprising the step of recirculating excess water back into the fluid reservoir via a fluid recirculation system.

20. The method of claim 16, further comprising the step of providing an audio signal, visual signal or a combination of signals thereof when the fluid reservoir contains an amount of fluid that is less than a desired level of fluid.
